(19) United States
(12) Patent Application Publication
(10) Pub. No.: US 2010/0036903 A1
(43) Pub. Date: Feb. 11, 2010

(54) DISTRIBUTED LOAD BALANCER

(75) Inventors: Najam Ahmad, Redmond, WA (US); Albert Gordon Greenberg, Seattle, WA (US); Parantap Lahiri, Redmond, WA (US); Dave Maltz, Bellevue, WA (US); Parveen K. Patel, Redmond, WA (US); Sudipta Sengupta, Redmond, WA (US); Kushagra V. Vaid, Sammamish, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/189,438

(22) Filed: Aug. 11, 2008

(51) Int. Cl. G06F 15/16

(52) U.S. Cl. 709/202

(57) ABSTRACT

Systems and methods that distribute load balancing functionalities in a data center. A network of demultiplexers and load balancer servers enable a calculated scaling and growth operation, wherein capacity of load balancing operation can be adjusted by changing the number of load balancer servers. Accordingly, load balancing functionality/design can be disaggregated to increase resilience and flexibility for both the load balancing and switching mechanisms of the data center.

### BACKGROUND

Global communications networks such as the Internet are now ubiquitous with an increasingly larger number of private and corporate users dependent on such networks for communications and data transfer operations. As communications security improves, more data are expected to traverse the global communications data backbone between sources and destinations, such as server hosts, hence placing increasing demands on entities that handle and store data. Typically, such increased demands are addressed at the destination by adding more switching devices and servers to handle the load.

Network load-balancers provide client access to services hosted by a collection of servers (e.g., “hosts”). Clients connect to (or through) a load-balancer, which from the client's perspective, transparently forwards them to a host according to a set of rules. In general, the load balancing context includes packets in the form of sequences that are represented as sessions; wherein such sessions should typically be allocated among available hosts in a “balanced” manner. Moreover, every packet of each session should in general be directed to the same host, so long as the host is alive (e.g., in accordance with “session affinity”).

To address these issues, data center systems employ a monolithic load-balancer that monitors the status (e.g., liveness/load) of the hosts and maintains state in the form of a table of all active sessions. When a new session arrives, the load-balancer selects the least-loaded host that is available and assigns the session to that host. Likewise and to provide session affinity, the load-balancer must “remember” such assignment/routing decision by adding an entry to its session table. When subsequent packets for this session arrive at the load-balancer, a single table lookup determines the correct host. However, an individual load-balancer can be both a single point of failure and a bottleneck, wherein size of its session table (and thereby the amount of state maintained) grows with increased throughput—and the routing decisions for existing session traffic require a state lookup (one per packet). Circumventing these limitations require multiple monolithic load-balancers working in tandem (scale-out), and/or larger, more powerful load-balancers (scale-up). However, scaling-out these load balancing devices is complicated, due most notably to the need of maintaining consistent state among the load-balancers. Likewise, scaling them up is expensive, since cost versus throughput in fixed hardware is non-linear (e.g., a load-balancer capable of twice the throughput costs significantly more than twice the price). Moreover, reliability concerns with monolithic load balancers further add to challenges involved, as failure of such systems cannot be readily compensated for without substantial costs.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides for a distributed load balancer system that enables gradual scaling and growth for capacity of a data center, via a network of demultiplexer(s) (and/or multiplexers) and load balancer servers that continuously adapt to increasing demands—(as opposed to adding another monolithic/integrated load balancer, wherein its full capacity can remain under utilized.) The demultiplexer can function as an interface between switching systems of the data center and load balancer servers (e.g., demultiplexer acting as an interface between L2 switches having 10G ports and PCs that have 1G port). Such load balancer servers include commodity machines (e.g., personal computers, laptops, and the like), which typically are deemed generic type machines not tailored for a specific load balancing purpose. The load balancer servers can further include virtual IP addresses (VIP identity), so that applications can direct their requests to address associated therewith and without specifying the particular server to use; wherein load balancing can occur through mapping the VIP to a plurality of Media Access Control addresses representing individual servers (MAC rotation). Moreover, such load balancer servers can be arranged in pairs or larger sets to enable speedy recovery from server failures. The demultiplexer re-directs the request to a respective load balancer server based on an examination of data stream packets. The failure of a demultiplexer can be hidden from the user by arranging them in buddy pairs attached to respective buddy L2 switches, and in case of an application server failure, the configuration can be modified or automatically set, so that traffic no longer is directed to the failing application server. As such, and from the user's perspective, availability is maintained

Moreover, the demultiplexer can examine IP headers of incoming data stream (e.g., the 5-tuple, source address, source port, destination address, destination port, protocol), for a subsequent transfer thereof to a respective load balancer server(s), via a mapping component. Accordingly, data packets can be partitioned based on properties of the packet assigned to a load balancer server and environmental factors (e.g., current load on load balancer servers). The load balancer servers further possess knowledge regarding operation of the servers that service incoming requests to the data center (e.g., request servicing servers, POD servers, and the like). Accordingly, from a client side a single IP address is employed for submitting requests to the data center, which provides transparency for the plurality of request servicing servers as presented to the client.

In a related aspect, a mapping component associated with the demultiplexer can examine an incoming data stream, and assign all packets associated therewith to a load balancer server (e.g., stateless mapping)—wherein data packets are partitioned based on properties of the packet and environmental factors such as current load on servers, and the like. Subsequently, requests can be forwarded from the load balancer servers to the request servicing servers. Such an arrangement increases stability for the system while increasing flexibility for a scaling thereof. Accordingly, load balancing functionality/design can be disaggregated to increase resilience and flexibility for both the load balancing and switching mechanisms. Such system further facilitates maintaining constant steady-state per-host bandwidth as system size increases. Furthermore, the load balancing scheme of the subject invention responds rapidly to changing load/traffic conditions in the system.

In one aspect, requests can be received by L2 switches and distributed by the demultiplexer throughout the load balancer servers (e.g., physical and/or logical interfaces, wherein multiple MAC addresses are associated with VIP.) Moreover, in a further aspect load balancing functionalities can be integrated as part of top of rack (TOR) switches, to further enhance their functionality—wherein the VIP identity can reside in such TOR switches that enables the rack of servers to act as unit with the computational power of all the servers available to requests sent to the VIP identity or identities.

According to a methodology of the subject innovation, initially a request(s) is received by the data center, wherein such incoming request is routed via zero or more switches to the demultiplexer. Such demultiplexer further interfaces the switches with a plurality of load balancer servers, wherein the demultiplexer re-directs the request to a respective load balancer based on an examination of data stream packets. The distributed arrangement of the subject innovation enables a calculated scaling and growth operation, wherein capacity of load balancing operation is adjusted by changing the number of load balancer servers; hence mitigating underutilization of services. Moreover, each request can be handled by a different load balancer server even though conceptually all such requests are submitted to a single IP address associated with the data center.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a distributed load balancer system according to an aspect of the subject innovation.

FIG. 2 illustrates a prior art system that employs monolithic and/or integrated load balancer as part of a data center operation.

FIG. 3 illustrates a particular aspect of top-of-rack switches with load balancing functionality according to a further aspect of the subject innovation.

FIG. 4 illustrates a methodology of distributing tasks in accordance with an aspect of the subject innovation.

FIG. 5 illustrates a further load balancer system with a mapping component according to a further aspect of the subject innovation.

FIG. 6 illustrates a particular methodology of distributing load balancing functionality as part of a system according to a further aspect of the subject innovation.

FIG. 7 illustrates a particular aspect of a load distribution system that positions load balancer servers as part of racks associated with request servicing servers.

FIG. 8 illustrates an artificial intelligence component that facilitates load balancing in accordance with a further aspect of the subject innovation.

FIG. 9 illustrates a schematic block diagram of a suitable operating environment for implementing aspects of the subject innovation.

FIG. 10 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

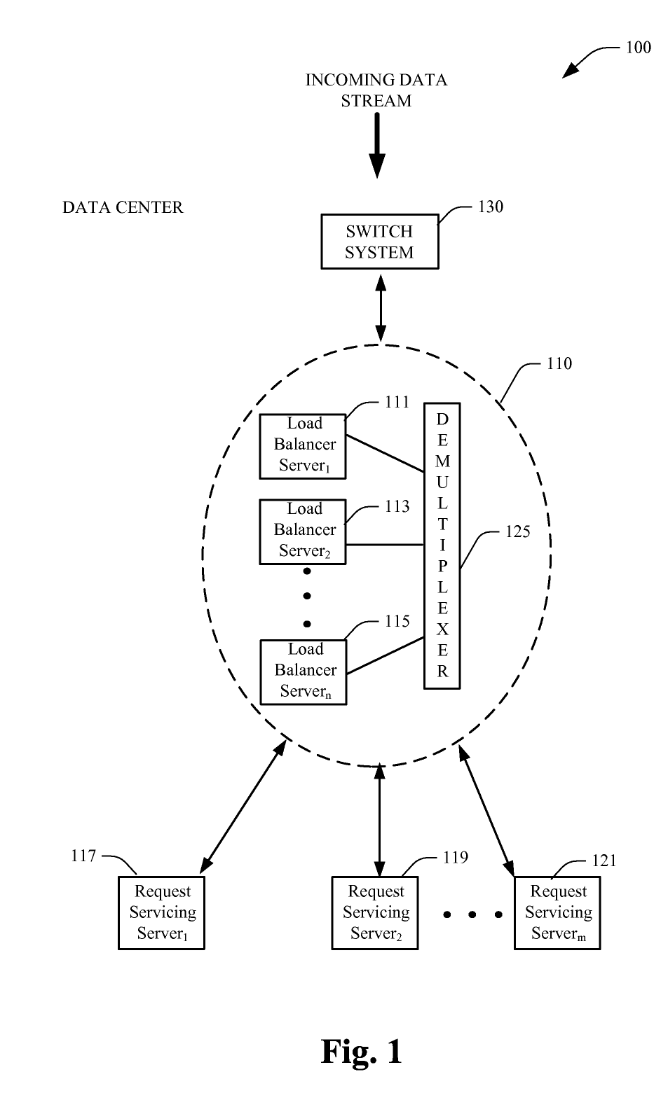

FIG. 1 illustrates a schematic block diagram for a distributed load balancer system 110 according to an aspect of the subject innovation, which enables gradual scaling and growth for capacity of a data center 100. In general, the data center 100 represents a central repository that facilitates distributed processing (e.g., client/server), wherein applications and/or services can be hosted thereby (e.g., databases, file servers, application servers, middleware, and the like). For example, the data center 100 can include any of data, code, or processing capabilities for web services, cloud services, enterprise resource processing (ERP), and customer relationship management (CRM) to facilitate distributed processing thereof. Moreover, such data center 100 can include server racks, telecommunication racks, power distribution units, computer-room air conditioning units, and the like. Similarly, data bases associated with such data center can include a rack layout table including rack item id, name, data center, collocation, row, cabinet, beginning slot number and number of slots the item occupies.

The distributed load balancer system 110 can be implemented as part of an arrangement of a demultiplexer(s) 125 and servers dedicated to load balancing (e.g., load balancer servers) 111, 113, 115 (1 to n, where n is an integer.) As described in this application, the term demultiplexer typically refers to describing the distribution of workload over the request servicing servers. Nonetheless, when providing connectivity between the external users or the sources of workload and the request servicing server, then a multiplexer and/or demultiplexer can further be implemented. The demultiplexer 125 can obtain traffic from the switch system 130 and redistribute it to the load balancer servers 111, 113, 115, wherein such load balancer servers can employ commodity machines such as personal computers, laptops, and the like, which typically are deemed generic type machines not tailored for a specific load balancing purpose. The demultiplexer 125 can include both hardware and software components, for examination of IP headers of an incoming data stream (e.g., the 5-tuple, source address, source port, destination address, destination port, protocol), for a subsequent transfer thereof to a respective load balancer server(s), wherein data packets are partitioned based on properties of the packet/environmental factors (e.g., current load on load balancer servers), and assigned to a load balancer server 111, 113, 115. Such assignment can further be facilitated via a mapping component (not shown) that is associated with the demultiplexer 125. For example, the mapping component can distribute data packets to the load balancer servers 111, 113, 115 using mechanisms such as round-robin, random, or layer-3/4 hashing (to preserve in-order delivery of packets for a given session), and the like.

Likewise, the load balancer servers 111, 113, 115 can subsequently route the packets for a servicing thereof to a plurality of request servicing servers 117, 119, 121 (1 to m, where m is an integer) as determined by a routing function. For example, routing of the packet stream can employ multiple sessions, wherein the assignment to a request servicing server occurs after assessing the liveness and load of all such request servicing servers 117, 119, 121. Put differently, the load balancer servers 111, 113, 115 possess knowledge regarding operation of the request servicing servers 117, 119, 121 that service incoming requests to the data center (e.g., request servicing servers, POD servers, and the like).

Such an arrangement of distributed load balancing within the data center 100 increases flexibility for a scaling of load balancing capabilities based on requirements of the data center 100. As such, load balancing functionality/design can be disaggregated to increase resilience and flexibility for both the load balancing and switching mechanisms. This facilitates maintaining constant steady-state per-host bandwidth as system size increases. Moreover, the load balancing scheme of the subject invention responds rapidly to changing load/traffic conditions in the system. It is to be appreciated that FIG. 1 is exemplary in nature and the demultiplexer can also be part of the switches or a router(s).

In a related aspect, distributing a workload—such as allocating a series of requests among a plurality of servers—can be separated into two stages. In the first stage, the workload can be divided among a plurality of load balancing servers using a first type of hardware, software, and workload distribution algorithm. In the second stage, a load balancing server can further divide workload assigned thereto by the first stage, among a plurality of request servicing servers via a second type of hardware, software, and workload distribution algorithm.

For example, the first type of hardware, software, and workload distribution algorithm can be selected to maximize the performance, reduce the amount of session state required, and minimize the cost of handling a large workload by employing substantially simple operations that are implemented primarily in hardware. As such, the first type of hardware, software, and workload distribution algorithm can be referred to as a demultiplexer 125. As described in detail infra, particular implementations for the first type of hardware, software, and workload distribution algorithm can include: (1) use of a plurality of switches or routers as the hardware, a link-state protocol as the software (e.g., OSPF), the destination IP address as the session ID, and equal-cost multipath as the workload distribution algorithm; (2) use of a single switch as the hardware, the link-bonding capability of the switch as the software (also referred to as a port-channel in the terminology of a major switch vendor), and one of the various algorithms provided by the switch's link-bonding implementation as the algorithm (e.g., a hash of the IP 5-tuple, round robin, and the like).

According to a further aspect, the second type of hardware, software, and workload distribution algorithm can be chosen to maximize the versatility of the load balancing server. Typically, it is desirable for the load balancing server to be capable of implementing any workload distribution algorithm, which employs as part of its decision making process the information available (e.g., information related to the current workload it is serving; a deep inspection of the request or workload item that should be directed to an appropriate request servicing server; the workload other load balancing servers are serving; the workload or the status of the components implementing the multiplexer/demultiplexer; the workload or status of the request servicing servers; predictions about the workload or status of any of these elements for times in the future, and the like.) Furthermore, it is desirable that the load balancing server be able to offload functionality from the request servicing servers, such as encryption, decryption, authentication, or logging. A particular aspect for the second type of hardware can be a general purpose computer, of the type commonly used as data center servers, desktop/home computers, or laptops due to the low cost of such devices and their ability to accept and execute software and algorithms that implement any of the desired functionality.

It is to be appreciated that the first type and second type of hardware, software, and workload distribution algorithm can be combined in multiple ways depending on the target cost, the target performance, and the configuration of existing equipment, for example. It is also appreciated that the subject innovation enables a substantially simple high-speed mechanism (the hardware, software, and workload distribution algorithm of the first type) for disaggregation of the workload to a level at which commodity servers can be used; and to implement desired distribution of requests to request servicing servers (e.g., employing arbitrary software that can be run on personal computers, without a requirement of substantial investment in hardware.). Moreover, an arrangement according to the subject innovation is incrementally scalable, so that as the workload increases or decreases the number of load balancing servers can be respectively increased or decreased to match the workload. The granularity at which capacity is added to or subtracted from the distributed load balancing system 110 is significantly finer grain than the granularity for a conventional system (e.g., conventional monolithic load balancers),

Conceptually, there can exist a first network between the demultiplexer and load balancing servers, and a second network between the load balancing servers and the request servicing servers. Each of such networks can be constructed of any number of routers, switches or links (e.g., including none). Moreover, there typically exists no constraints on the type of either the first network or the second network. For example, the networks can be layer 2, layer 3, or layer 4 networks or any combination thereof.

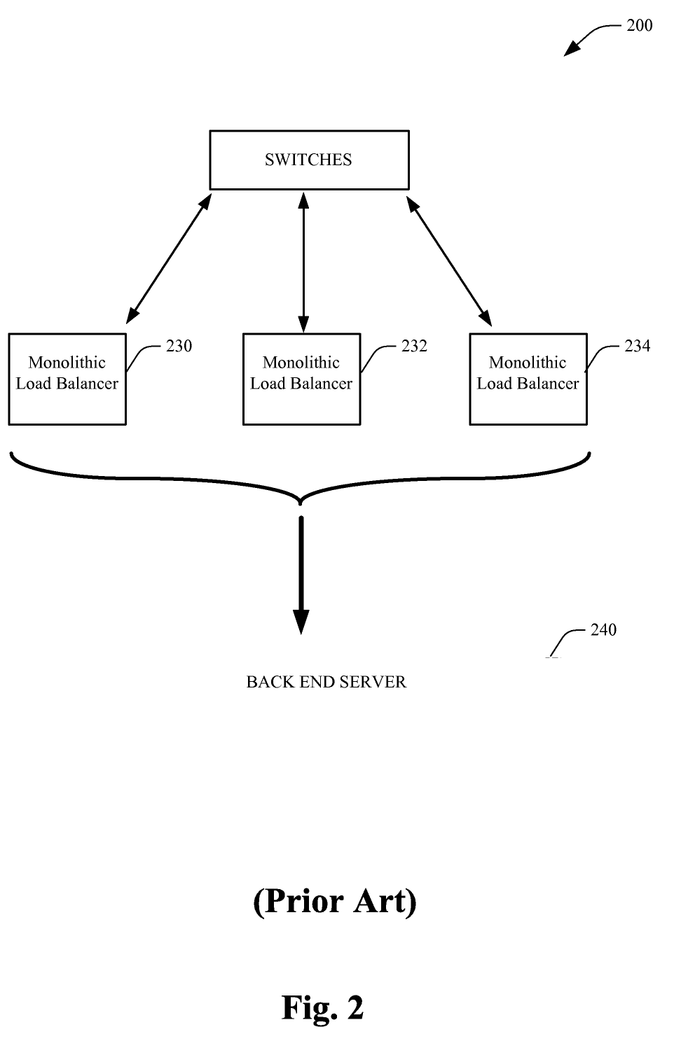

FIG. 2 illustrates a conventional load balancing system that employs a monolithic load balancer(s) 230, 232, 234—as opposed to distributed load balancer servers of the subject innovation. The monolithic load balancer 230, 232, 234 typically spreads service requests among various request servicing servers of the datacenter. For example, the monolithic load balancer 230, 232, 234 forwards requests to one of the “backend” servers 240, which usually replies to the monolithic load balancer 230, 232, 234—without the client requesting data knowing about the internal separation of functions. Additional security is obtained when preventing clients from contacting backend servers directly, by hiding the structure of the internal network and preventing attacks on the kernel's network stack or unrelated services running on other ports.

As the capacity of the data center 200 increases, another monolithic load balancer is added—yet the capacity associated therewith remains unused until the next of expansion for the data center. However, this can be an expensive proposition in terms of hardware, software, setup, and administration. Accordingly, by using monolithic load balancer, enhancement to the system cannot be efficiently tailored to accommodate incremental growth of the data center. In a related aspect, such monolithic load balancer typically is not aware of the operation of the back end servers 240 and in general does not readily supply intelligent distribution choices among machines associated with the back end server 240.

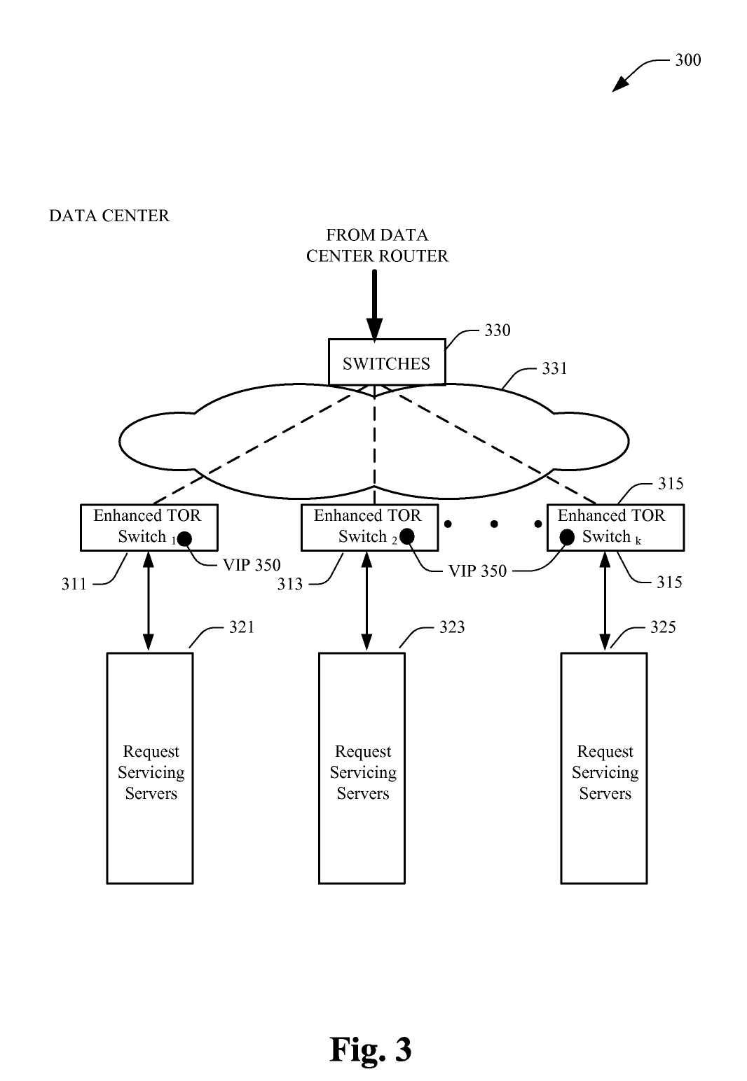

FIG. 3 illustrates a further aspect for a disaggregated and distributed load balancer system 300 according to a further aspect of the subject innovation. The system 300 enables load balancing functionalities to be integrated as part of top of rack (TOR) switches 311, 313, 315 (1 to k, where k is an integer) to further enhance their functionality and form an enhanced TOR.

In the system 300, the VIP identity can reside in TOR switches 311, 313, 315, which can further enable layer 3 functionalities, for example. Typically, the TOR switching can supply various architectural advantages, such as fast port-to-port switching for servers within the rack, predictable oversubscription of the uplink and smaller switching domains (one per rack) to aid in fault isolation and containment. In such an arrangement the VIP(s) 350 can reside in multiple TORs. The functionality of the multiplexer/demultiplexer can be implemented using the equal cost multi-path routing capability of the switches and/or routers to create a distributed multiplexer/demultiplexer as represented in FIG. 3 by cloud schematic 331 As such, load balancer servers functionality can reside in the enhanced TOR.

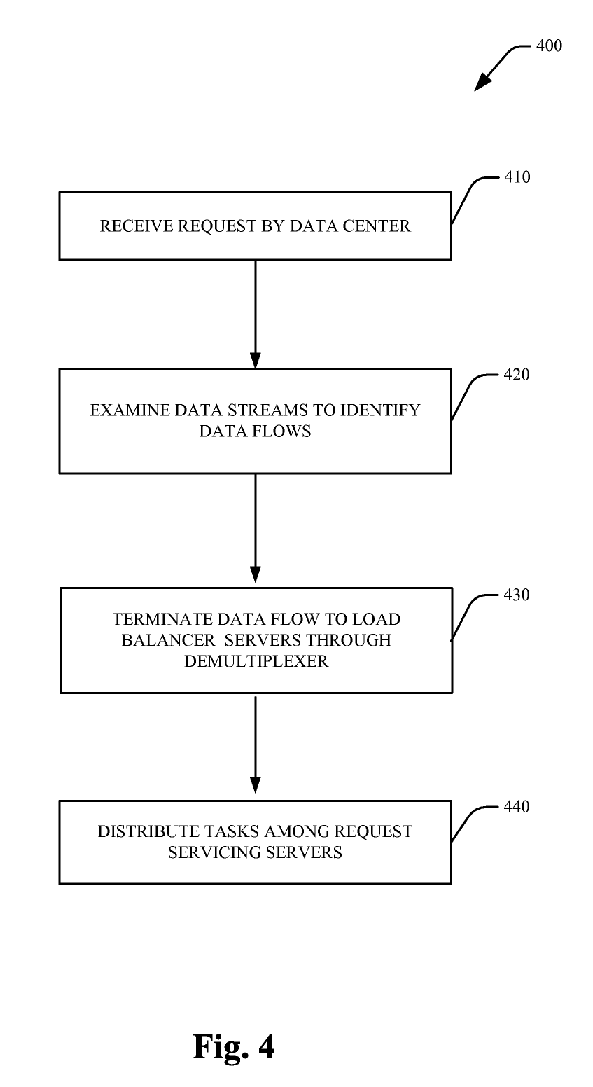

FIG. 4 illustrates a further methodology 400 of implementing a distributed load balancer system according to a further aspect of the subject innovation. While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described. Initially, and at 410 a request is received by the data center, as a data stream with a plurality of packets associated therewith, for example.

Next and at 420, such incoming data packets can be examined to identify fields for identification of a flow, wherein every packet in the same flow can follow a same path to terminate at the same load balancer server at 430. As such, packets can be partitioned based on properties of the packets and environmental factors such as health, availability, service time, or load of the request servicing servers; health, availability or load of the load balancing servers; health or availability of the components implementing the demultiplexer, wherein redirecting of the packets to the load balancer servers occurs in an intelligent manner that is both network path aware and service aware, as pertained to the load balancer servers. Well known techniques, such as consistent hashing, can be used to direct flows to a load balancer in manner that is responsive to changes in the factors that affect the assignment of flows to load balancers. Next and at 440, the load balancer server can partition tasks involved among the plurality of service requesting servers, for example.

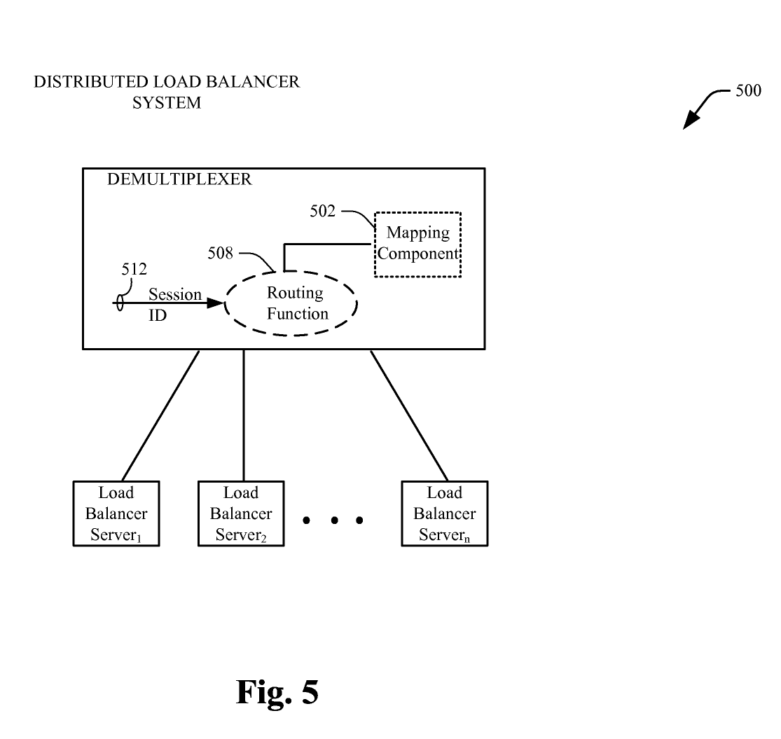

FIG. 5 illustrates a mapping component 502 that can provide for a stateless mapping to the load balancer servers according to an aspect of the subject innovation. The mapping component 502 can direct each session packet to a designated load balancer server as predefined by the routing function 508. It is noted that a session is a logical series of requests and responses between two network entities that can span several protocols, many individual connections, and can last an indeterminate length of time. Some common session types include TCP (Transmission Control Protocol), FTP (File Transfer Protocol), SSL (Secure Socket Layer), IPSec (IP Security)/L2TP (Layer 2 Tunneling Protocol), PPTP (Point-to-Point Tunneling Protocol), RDP (Remote Desktop Protocol), and the like. The characterization of a session for most protocols is well defined, such that there exists a clear beginning and end to each session, and an associated identifier by which to distinguish such session. Some session types, however, can have a distinct beginning, but an inferred end such as an idle timeout or maximum session duration.

Since, for each session packet, the session ID 512 is used as the input to the routing function 508, session affinity is preserved; that is, each packet of a given session can be routed to the same load balancer server. Further, the mapping component 502 determines to which of the load balancer server each session will be assigned and routed, taking into consideration the current loading state of all load balancer servers.

The mapping component 502 detects and interrogates each session packet for routing information that includes the session ID 512 and/or special tag on the first session packet, and the last session packet, for example. Thus, any packet that is not either the first packet or the last packet, is considered an intermediate session packet. Moreover, when a session ID has been generated and assigned, it typically will not be used again for subsequent sessions, such that there will not be ambiguity regarding the session to which a given packet belongs. Generally, an assumption can be made that a given session ID is unique for a session, whereby uniqueness is provided by standard network principles or components.

Hence, data packets can be partitioned based on properties of the packet and environmental factors (e.g., current load on load balancer servers), and assigned to a load balancer server. The load balancer servers further possess knowledge regarding operation of other servers that service incoming requests to the data center (e.g., request servicing servers, POD servers, and the like). Thus, the system 500 employs one or more routing functions that define the current availability for one or more of the load balancer servers. The routing function can further take into consideration destination loading such that packets of the same session continue to be routed to the same destination host to preserve session affinity.

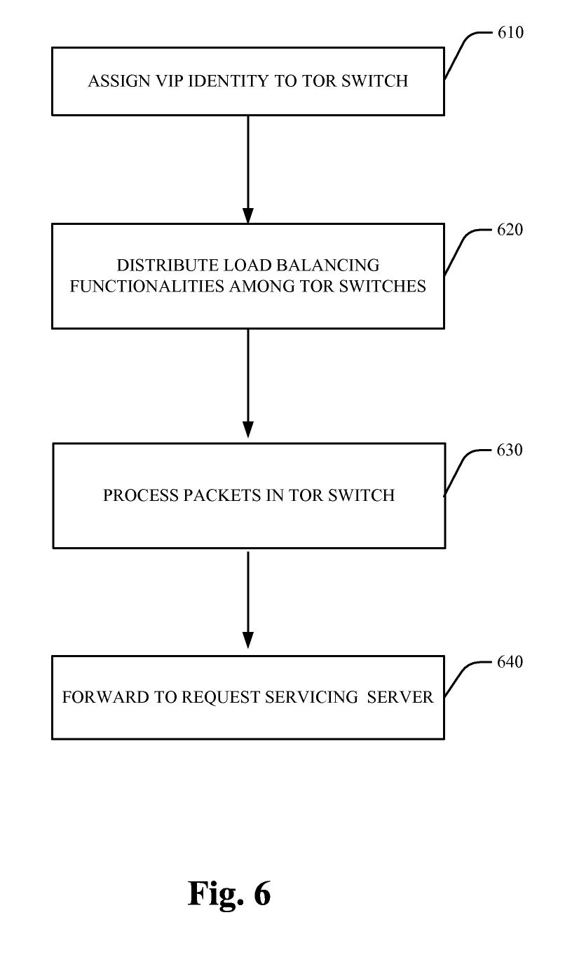

FIG. 6 illustrates a methodology of distributing load balancing capabilities among a plurality of TOR switches. Initially, and at 610 a VIP identity can be assigned to a TOR switch, wherein when a VIP is assigned to multiple TORs, then equal cost multipath routing can load balance to multiple TORs. Multiple MAC addresses can associate with the VIP, wherein such virtual IP address can direct service requests to servers without specifying the particular server to use. As such, the TOR can redirect traffic using a hash or round robin algorithm to associated servers. Moreover, in case of a server failure, the configuration can be modified or automatically set so that traffic no longer is directed the failing server. Next and at 620, load balancing functionalities can be distributed among switches, wherein the load balancer server can reside as part of the TOR switch that is so enhanced. At 630 request received by the service data center can be forwarded to the TOR switch for processing packets associated with service requests. Moreover, mulitplexing/demultiplexing capabilities can be implemented as part of the TOR switches in the form of hardware and/or software components, to direct request to associated servicing servers in an intelligent manner that is both path aware and service aware, as pertained to the load balancer servers.

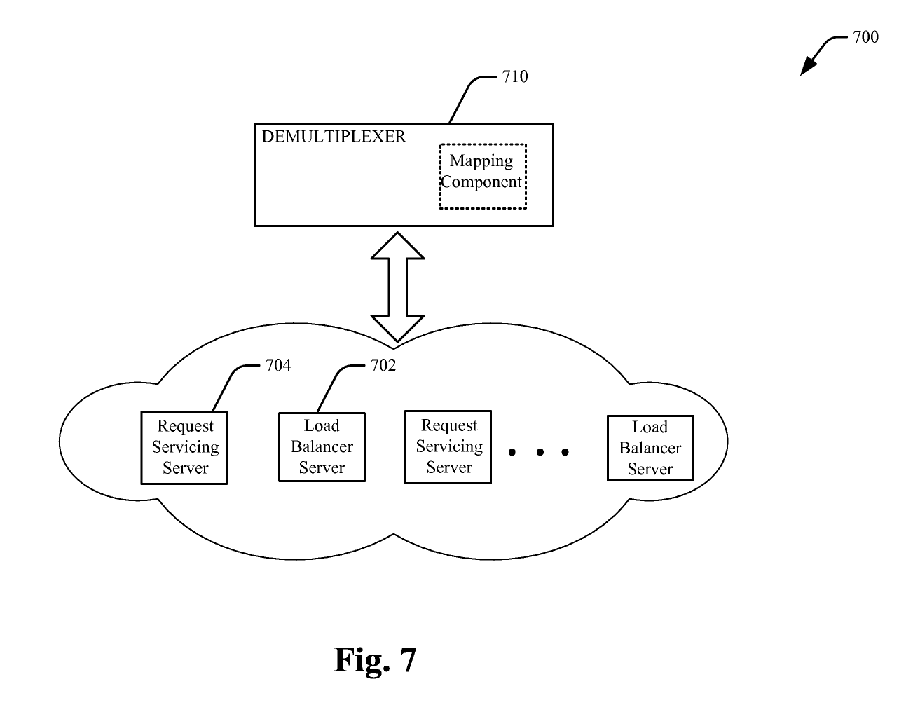

FIG. 7 illustrates a further aspect of a load distribution system 700 that positions the load balancer server(s) 702 as part of racks associated with request servicing servers 704. Such arrangement allows for additional load balancing as part of the service requesting servers, and the load balancer servers can further off load duties off the request servicing servers. The demultiplexer 710 further allows for tunneling incoming data streams into the load balancer server(s) 702. Tunnel(s) can be established from the demultiplexer 710 to the load balancer server 702 (and/or from the load balancing servers to the request servicing servers), wherein sessions are negotiated over such tunnel. Such tunneling can further be accompanied by establishing other tunnels to the service requesting servers depending on type of requests and/or switches (e.g., L2/L3) involved. The demultiplexer 710 can further designate the load balancer servers based on hashing functions, wherein the load balancer server can then communicate with a service requesting server.

For example, the demultiplexer 710 can generate an identical routing function that distributes the packet load in a balanced manner to the available load balancer servers and/or service requesting servers. The designated server continues to receive session packets in accordance with conventional packet routing schemes and technologies, for example. As such, the session information can be processed against the routing function to facilitate load balancing. The demultiplexer continues routing session packets of the same session to same host until the last packet is detected, to preserve session affinity.

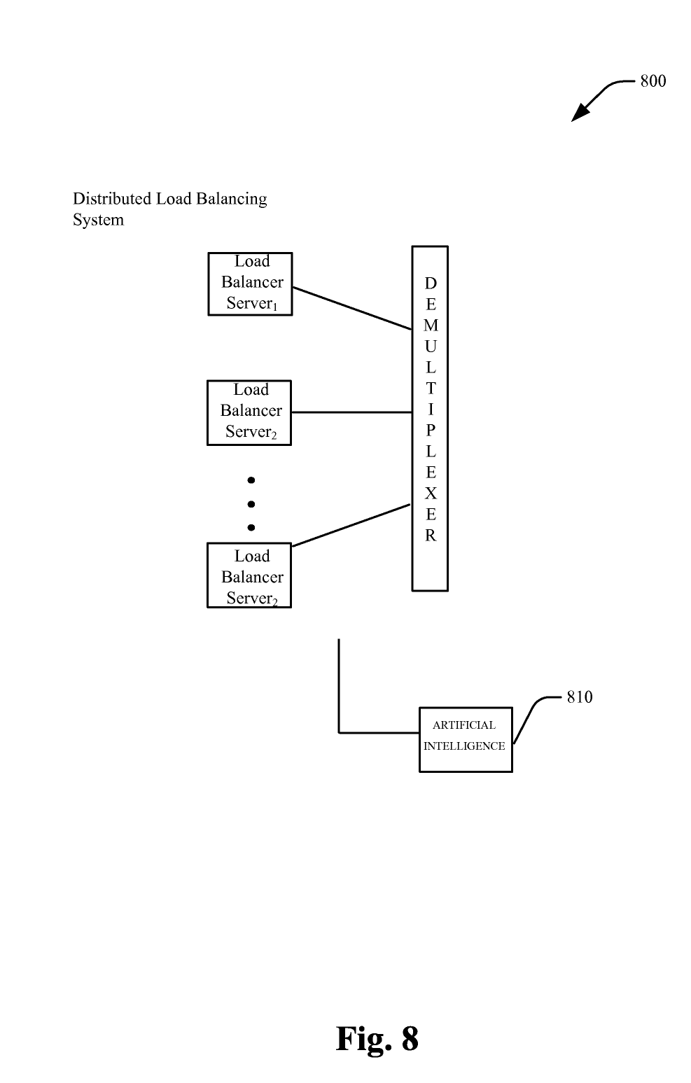

FIG. 8 illustrates a system 800 that employs an artificial intelligence (AI) component 810 that can be employed to facilitate inferring and/or determining when, where, how to distribute incoming request among load balancer servers and/or service requesting servers. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 810 can employ any of a variety of suitable AI-based schemes as described supra in connection with facilitating various aspects of the herein described invention. For example, a process for learning explicitly or implicitly how to balance tasks and loads in an intelligent manner can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

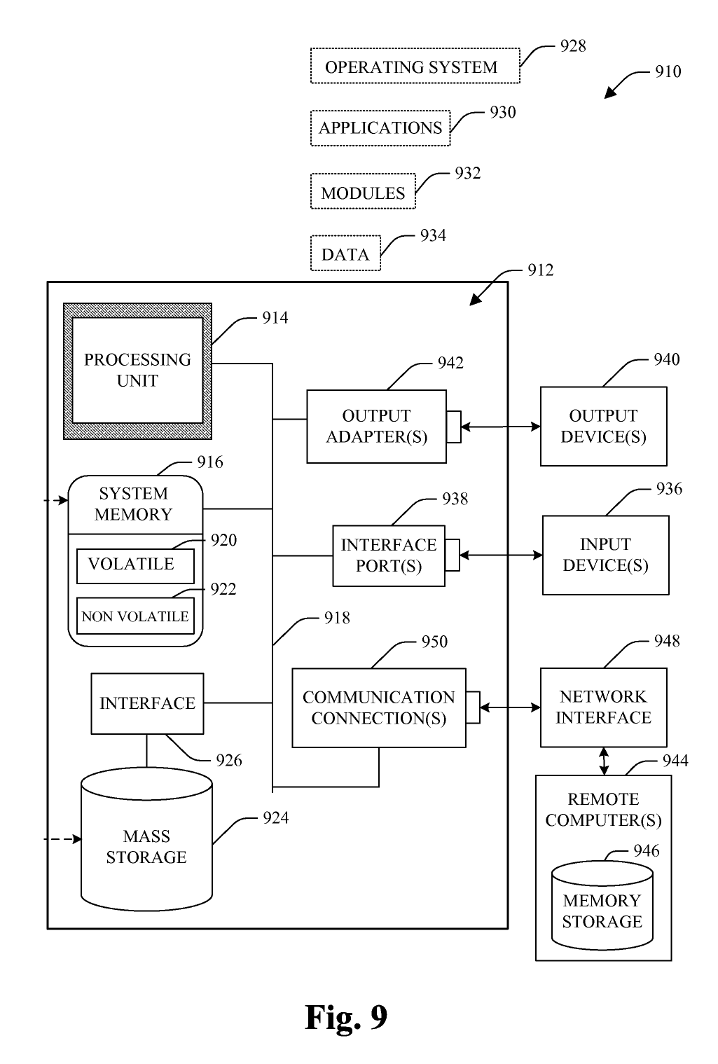

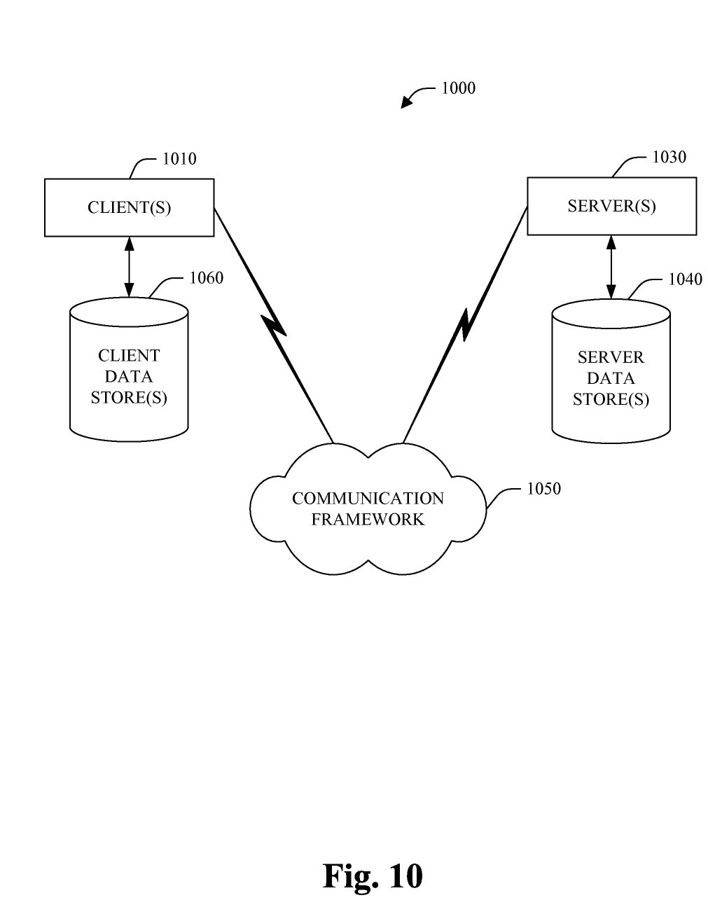

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of a distributed load balancing in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a demultiplexer component(s) that interfaces load balancer server(s) with a switching system of a data center; and
the load balancer server(s) distributes requests received by the data center among a plurality of request servicing servers.

2. The computer implemented system of claim 1 further comprising a top-of-rack (TOR) switch that includes the demultiplexer.

3. The computer implemented system of claim 1, where the demultiplexer is part of a switch or a router.

4. The computer implemented system of claim 1, the demultiplexer further comprising a mapping component that employs a routing function to direct a request to the load balancer server.

5. The computer implemented system of claim 1, the demultiplexer and the load balancer servers are associated with an L2, L3, or L4 network or a combination thereof.

6. The computer implemented system of claim 1, the load balancer server is selected from a group of a laptop, personal computer or a commodity machine not tailored for load balancing functionalities.

7. The computer implemented system of claim 4, the routing function implements media access control (MAC) rotation with an IP address designatable to a plurality of MAC addresses.

8. The computer implemented system of claim 1 further comprising an artificial intelligence component that facilitates load balancing as part of a distributed system.

9. A computer implemented method comprising the following computer executable acts:
distributing load balancing functionality within a data center via a demultiplexer(s) and load balancer servers; and
directing an incoming request received to the load balancer servers via the demultiplexer.

10. The computer implemented method of claim 9 further comprising adjusting number of load balancer servers to accommodate incoming requests.

11. The computer implemented method of claim 9 further comprising employing commodity computers as part of load balancer servers to execute work load distribution algorithms in software code.

12. The computer implemented method of claim 9 further comprising distributing tasks among request servicing servers by the load balancer server.

13. The computer implemented method of claim 9 further comprising assignment of request to request servicing servers based on environmental factors.

14. The computer implemented method of claim 9 further comprising implementing load balancing functionalities as part of a switch, a router, or top-of-rack (TOR) switches, or a combination thereof.

15. The computer implemented method of claim 14 further comprising assigning VIP identity to a TOR switch(es).

16. The computer implemented method of claim 9 further comprising examining data streams by the demultiplexer to identify data flows.

17. The computer implemented method of claim 9, the directing act is performed in an intelligent manner that is network path aware and service aware.

18. The computer implemented method of claim 17 further comprising employing at least one of a tunneling from the demultiplexer to the load balancer servers and tunneling from the load balancing servers to the request servicing servers.

19. The computer implemented method of claim 9 further comprising the load balancing servers offloading functionality from the request servicing servers.

20. A computer implemented system comprising the following computer executable components:
means for interfacing a switching system of a data center with a distributed load balancer system; and
means for distributing requests received by the data center among a plurality of request servicing servers.
